(19) United States
(12) Patent Application Publication
(10) Pub. No.: US 2017/0054333 A1
(43) Pub. Date: Feb. 23, 2017

(54) FOREIGN-BODY DETECTION DEVICE AND POWER INDUCTIVE CHARGING DEVICE

(71) Applicant: Continental Automotive GmbH, Hannover (DE)

(72) Inventors: Thomas ROEHRL, Barbing (DE); Peter SAEGER, Friedrichsdorf (DE); Benjamin HENRICH, Schweppenhausen (DE)

(21) Appl. No.: 15/307,228

(22) PCT Filed: Apr. 9, 2015
(86) PCT No.: PCT/EP2015/057661

§ 371 Date: Oct. 27, 2016

(30) Foreign Application Priority Data
Apr. 28, 2014 (DE) 10 2014 207 885.7

(51) Int. Cl. H02J 50/60; B60L 11/18; H02J 50/12; G01V 3/10

(52) U.S. Cl. CPC H02J 50/60; G01V 3/101; B60L 11/182; H02J 50/12; B60L 2230/10

(57) ABSTRACT

A foreign-body detection device has coils arranged next to each other to form ring-shaped sectors. Several coils follow one another both along a circumferential direction of the ring sectors and perpendicular thereto. A power inductive charging device comprises the foreign-body detection device and a power coil arrangement on which the power inductive charging device is arranged.

### BACKGROUND

The practice of charging vehicles having a hybrid drive or purely electric vehicles by means of stationary current sources is known; this can occur in a wired fashion (“plug-in”) or by inductive transfer. In the case of inductive transfer, an alternating magnetic field is generated by a stationary transmission coil, said alternating magnetic field leading to induced current in a vehicle-side reception coil. As there are usually gaps between the stationary transmission coil and the vehicle-side reception coil, an induced current is also applied to metallic foreign bodies in the vicinity of, or on, the transmission coil. This leads to strong heating of the metallic foreign body, particularly in the case of power applications in which charging is carried out with a charging power of typically more than two kilowatts.

US 2010/0169062 A1 proposes the use of a foreign-body detection coil to be able to detect foreign bodies on the basis of changes in the magnetic field of the transmission coil. Here, use is made of a foreign-object detection coil which emerges from windings of a coil wire parallel to the coil plane of a transmission coil, wherein the emerging coil sections extend over the entire radius. It was recognized that such coil sections do not enable a sufficient spatial accuracy.

### SUMMARY

It is therefore an object of the invention to highlight an option with which foreign bodies can be detected more precisely.

It was recognized that a precise detection and localization of a foreign object can be realized with a multiplicity of coils arranged in planar fashion, said coils being distributed in two different directions. As a result, a planar resolution (within the meaning of pixels) with coils as sensor elements emerges, the spatial resolution of which is not restricted in any direction, while the prior art only offers an angular resolution but no distance resolution (perpendicular to the direction of the angular resolution). In particular, the coils can be distributed in accordance with a resolution in polar coordinates (i.e. resolution in angles and distances) in order thus to be able to take into account the round or circular geometry of numerous primary coils.

In order to determine the angle within the meaning of polar coordinates, the coils are distributed along circumferential lines, in particular substantially along circles, ovals or ellipses. In order to determine the distance within the meaning of polar coordinates, the coils are distributed in rings (which lie in one another or which are nested or which are aligned in succession from the inside to the outside), in particular substantially along circular, oval or elliptic rings. As a result, a good two-dimensional resolution emerges. Since this “round” curve form along which the coils are distributed furthermore corresponds to several common coil forms of transmission or primary coils, there is no need for adaptations due to different forms of the foreign-body detection device in relation to the magnetic field of the transmission coil.

The rings are not necessarily circular rings. The rings can have a polygonal basic form, in particular with rounded corners. In particular, square or rectangular rings lying on one another can be provided as basic form for the grouped distribution of coils. Like circular or, in general, round rings, rings with a polygonal form can also be subdivided into arc sections or angle sections, as a result of which sectors or ring sectors emerge. The selection of the ring and the selection of the angle result in a specific sector, which corresponds to a coil or along which the coil extends. A coil is assigned to each sector, as a result of which the planar resolution (i.e. resolution in different directions) and the resultant improved resolution emerge.

A foreign-body detection device with a plurality of coils is proposed. These have planar distribution and, in particular, are arranged next to one another. The coils are embodied in the form of sectors and, in particular, ring sectors. Here, a ring refers not only to a circular ring but also to oval or ellipsoid rings, and also rings which follow a polygonal form. In particular, the ring can have a hexagonal form, preferably in the form of a regular hexagon which can have rounded corners. The ring can be defined by an outer and inner closed line, with both lines being arranged concentrically in relation to one another. The area between these lines, which can also be considered to be the edge region of the area which is surrounded by the outer closed lines, is the region in which conductors of the coils extend or in which windings extend. The conductors or windings encompass the area which is defined by the inner closed lines. Therefore, the last-mentioned area forms the coil area. The inner closed line and the outer closed line have the same basic form and can by within this meaning, a ring can be considered to be a closed edge region of a closed area, the circumference of which constitutes a closed curve. The edge region can have a constant, or else a varying, thickness along the circumferential extent thereof. In particular, the edge region can have one, two, four or more axes of symmetry. For the purposes of subdivision into angular regions (in order to realize an angle-dependent resolution), the rings are subdivided in sectors (or angular regions). These are preferably configured with a constant length or arc length for all rings or along the same ring. The angle range or the arc length, which the angle interval which is respectively scanned by the sectors, can be constant or increase (or else decrease) to the outer edge of the foreign-body detection device. A plurality of coils follow one another in the circumferential direction. Furthermore, a plurality of coils follow one another perpendicular thereto (i.e. toward the outer edge of the foreign-body detection device). The coils can be aligned with the same angle in relation to one another toward the outer edge of the foreign-body detection device or they can be offset from one another in respect of the angle (i.e. in the circumferential direction). Preferably, the coils are arranged along a plurality of concentric rings.

The coils can be arranged next to one another and form groups lying within one another. In the case of such a group, at least one coil lies within a coil encompassing the latter. In particular, a plurality of coils lie within one coil. The coils lying therewithin are arranged next to one another and can substantially completely cover the inner area of the coil encompassing the former, for example with the exception of gaps within which connection lines extend to the coils lying on the inside. In other words, one coil area, or preferably a plurality of coil areas of further coils (lying therewithin), can be arranged in the coil area of a coil. This enables the approximate position detection by means of the coil which encompasses the at least one coil lying therewithin, while the coils lying therewithin detect the position within the encompassing coil with, compared thereto, a finer spatial resolution. There can also be more than two levels of resolution by virtue of at least one coil, which is encompassed by a further coil, itself encompassing further coils, at least one further coil. Therefore, the at least one coil lying therewithin can itself be a coil encompassing at least one further coil. Coils which encompass further coils can be used for the quick detection of objects while the coils encompassed by this coil serve for more detailed position determination within the encompassing coils.

The coils preferably have sensitivities which (apart from a predefined tolerance range) correspond to one another. This can apply to all coils of the foreign-body detection device, but preferably only applies to a subgroup or, in each case, to a plurality of subgroups of coils. Particularly in the case of a radially extending field strength profile, coils situated with a different proximity to the outer edge of the foreign-body detection device can have different sensitivities while coils which have the same distance from the outer edge have the same sensitivity and therefore do not deviate from one another—apart from a predefined tolerance range. In other words, coils lying on the same ring have substantially the same sensitivity. However, coils which lie on different rings can also have the same sensitivity. Alternatively, the sensitivities of coils on different rings (i.e. at different distances from the outer edge) can differ, for example to account for a radial field-strength profile and, for example, to at least partly compensate a field which decreases toward the outside by way of a sensitivity which increases toward the outside.

Therefore, the multiplicity of coils can be subdivided into at least one subgroup of coils (i.e. have one subgroup or be divided into a plurality of subgroups), with the coils of the same subgroup having sensitivities which do not deviate from one another by more than a predetermined tolerance range. By way of example, these subgroups correspond to coils which are situated on the same ring or which are geometrically grouped in a different manner, for example as described above.

The subdivision into subgroups can be a geometric grouping, for example a grouping along the circumferential direction of the foreign-body detection device or perpendicular thereto. The coils of the same subgroup are, for example, arranged along the circumferential direction. Alternatively, or in combination herewith, the coils of the same subgroup can be arranged perpendicular to the circumferential direction, for example along a straight line which leads through the center of the foreign-body detection device. The aforementioned constitutes an option for grouping the coils geometrically into subgroups with specific properties (sensitivity). The alignment of the coils is preferably not affected thereby; rather, the coils (or the principal axes of the coil areas) are preferably aligned along the rings (which in circumferential direction). The normals of the coil areas are parallel to one another and preferably substantially point in the same direction.

A further aspect lies in the targeted matching or configuration of the sensitivities of the coils. By way of example, the ratio of signal level of the (possibly additionally prepared) signal generated by the coils to the field strength of the field passing through the coils (i.e. through the coil area) is considered to be the sensitivity. In particular, this corresponds to the inductance of the coils, but can also relate to additional influencing variables which emerge from signal preparation, e.g. influencing variables such as damping, gain, quality of a resonant circuit in which the coil is situated, and the like. The sensitivities (predetermined by the grouping) are therefore defined e.g. by the respective inductance of the coils. Here, the sensitivities emerge from the number of turns, the (effective) coil cross section, the coil length, the (effective) magnetic permeability or the form of the coil.

Alternatively, or in combination therewith, it is possible for the signal generated by the coils to be prepared, e.g. by damping or amplification. This preparation has an influence on the sensitivity. Therefore, the sensitivity can be influenced by a matching circuit or level matching apparatus such as an amplifier or a voltage divider, which is disposed downstream of the coil. Here, the damping or gain can be fixedly prescribed, or else it can be variable, for example in order to match the foreign-body detection device individually or in a type-specific manner to a specific application (vehicle, transmission coil, base). Factors equal to, greater than or less than one are referred to as a gain factor, with gain factors less than one acting as damping. Instead of the term gain factor, use can therefore also be made of the magnitude of the transfer function (for a specific transmission frequency). The damping can also be realized within a resonant circuit such that the quality of the resonant circuit can be set or determined with the damping.

Alternatively, or in combination therewith, it is possible for the sensitivity of the respective coil to be defined or influenced by a respective detuning of resonant circuits, which are partly formed by the coils, in relation to a predetermined resonant frequency. Here, the respective coil forms a resonant circuit with a capacitance. The sensitivity is dependent on the degree of the deviation of the resonant frequency of the resonant circuit and the frequency of the alternating magnetic field with which the foreign-body detection device is excited (or the coils thereof are excited). Here, detuning can be carried out in a targeted manner (i.e. a high degree of deviation can be set) in order to set the sensitivity to be lower than in comparable resonant circuits which have a smaller degree of deviation. The detuning can be fixedly prescribed or else be variable, for example by connecting or removing an inductor or a capacitor from the resonant circuit. Furthermore, the quality of the resonant circuit (and, as a result thereof, the sensitivity) can be influenced by a fixedly predetermined or variable resistor, wherein, for example, a matching circuit for damping can be used to this end, as described above.

As noted above, the sensitivity can be influenced in a targeted manner. Here, use can be made of an adjustment device connected to the respective coil. Said adjustment device is configured to modify the inductance of the coil, the gain factor (and hence also the damping or the quality) or the detuning on the basis of an adjustment signal. This adjustable option for influencing the sensitivities of the coils enables a calibration, or else matching, to different vehicle types, charging stations or else to different, individual vehicles and charging stations. In particular, the adjustment device is a controllable switching element. Said switching element can be connected to taps and/or connectors of the respective coil. Furthermore, the adjustment device can be a variable series or parallel resistor, by means of which, in particular, it is possible to adjust the quality of a resonant circuit, within which the relevant coil is connected. Moreover, the adjustment device can be an amplifier with an adjustable gain factor and/or a damping member with an adjustable damping factor, for example a voltage divider. Finally, the adjustment device can be an inductor or capacitor which can be connected or separated in a controllable fashion. The adjustment device has a signal input and it is configured, as described above, to set the sensitivity in accordance with the signal at the signal input of the relevant coil. As already noted, the sensitivity can be set by changing properties of the coil (e.g. by adding/shorting turns) and/or by adjusting components which are connected to the relevant coil or which are disposed downstream thereof, e.g. damping members, amplifiers and others.

Below, further options are illustrated for adjusting the sensitivity in a controllable manner (in particular by way of an electrical control signal) or for configuring the sensitivity as described here. Accordingly, the foreign-body detection device has a level matching apparatus. The latter can comprise active or passive damping members and/or amplifiers. The damping members and/or amplifiers have an input connected to the respective coils. Alternatively, or in combination herewith, the level matching apparatus comprises components which are connected in parallel or in series with the coils. In particular, the components are capacitors, said capacitors forming a resonant circuit with the coils in each case. Alternatively, or in combination therewith, components are provided as resistors which form resonance damping elements with the coils. Furthermore, components can be present in the form of discrete inductors realized in the level matching apparatus. These can be embodied as matching elements for the inductance values of the coils.

A further aspect relates to embodiments with which the signals of the coils can be evaluated in a simple manner. Here, the foreign-body detection device has an evaluation circuit. The latter is linked to the coils or connected therewith. The evaluation circuit is configured to identify deviations, originating from the foreign bodies, in the signals.

The evaluation circuit has a comparator. The latter is configured to compare the signals of the coils with one another, to compare the signals of the coils with signals from reference coils or a different signal source, and/or it is configured to compare the signals of the coils with predetermined reference values (e.g. a reference value or a vector with a multiplicity of such reference values). By way of example, the comparison result corresponds to the strength of the deviation which in turn conveys the presence or the dimension and optionally also the location of the foreign object.

The comparator can have several signal inputs. These are connected to the coils of the at least one subgroup. The comparator can furthermore have at least one reference input which is configured to receive a reference value or a reference vector. In particular, the comparator is configured to establish a deviation between, firstly, the signal at the signal inputs and, secondly, the reference value or the reference vector, preferably a level difference.

Alternatively, the comparator can have a plurality of signal inputs. These are connected to the coils of the at least one subgroup. Here, the comparator furthermore has a memory which is configured to store a reference value or a reference vector, in particular a reference value or a reference vector which has an embodiment like the reference value described in the preceding paragraph or like a reference vector. The comparator is furthermore configured to establish a deviation between, firstly, the signal at the signal inputs and, secondly, the reference value or the reference vector, in particular a value difference (i.e. a level difference).

Furthermore, the comparator can have a plurality of signal inputs which are connected to various coils of the same subgroup. The comparator is configured to establish a deviation between the signals of the various coils. Here, the sensitivities of the coils of the subgroup are the same (apart from a deviation within a predetermined tolerance range). The comparator can have a plurality of groups of these plurality of signal inputs.

Furthermore, provision can be made of a multiplexer which connects a plurality of coils by multiplexing to the comparator (in particular to the same signal input of the comparator). Particularly in the case where signals of coils are compared with one another, provision can be made for a plurality of multiplexers, by means of which the comparator is connected to the coils, in order thereby to enable two comparison channels.

The foreign-body detection device can furthermore comprise an error signal generator. The latter is, in particular, disposed downstream of the comparator. As a result, the error signal generator can evaluate the result of the comparator, i.e. the deviation can evaluate whether or where a foreign body is present and how large the latter is (or how strongly it impairs the wireless energy transfer or constitutes a risk).

The error signal generator generates an error signal in the case of a deviation lying above a predetermined value. Said error signal conveys the occurrence of a deviation lying above the predetermined value. Alternatively, or in combination therewith, the error signal, for the output of which the error signal generator is configured, can convey the strength of the deviation or of a maximum of the deviation. Alternatively, or in combination therewith, the error signal can convey identification information or a location of the coil (or coils), the signal (or signals) of which deviates (or deviate) by more than the predetermined value. By way of example, a coil can be identified by way of a number which is only assigned to one coil within the foreign-body detection device. Furthermore, the error signal can convey identification information or a location of a subgroup of coils, from which the signal with the signal, which deviates by more than the predetermined value, originates.

Furthermore, there is a description of a power inductive charging device for charging inductively chargeable motor vehicles. This power inductive charging device comprises at least one foreign-body detection device as described here. The power inductive charging device furthermore comprises a power coil arrangement. All coils of the foreign-body detection device or some of the multiplicity of coils of the foreign-body detection device extend along said power coil arrangement. The foreign-body detection device and the power inductive charging device are arranged above one another. The power inductive charging device is preferably a stationary power inductive charging device, but it can also be a vehicle-side power inductive charging device, the power coil arrangement of which is configured to receive energy and carries the foreign-body detection device.

As noted above, the sensitivities of the coils can be created or set in such a way that the coils of one subgroup (for example coils which lie on the same ring) have the same sensitivities and hence the coils of a subgroup supply approximately the same signal level if no foreign bodies are present in the case of a transmission coil (i.e. power coil arrangement) with a form corresponding to the ring form. The foreign-body changes the field in such a way that a substantially constant field strength no longer prevails along the rings, as a result of which a deviation can be immediately traced back to the foreign body. This enables a simple comparison since, without foreign bodies, the same signal levels are present (for coils along a ring), and the only reason for deviation of the levels of coils along a ring lies in the presence of a foreign body. Here, the assumption of substantially constant field strengths along the respective rings is made. The sensitivities of the coils situated along a ring are configured appropriately to at least partly compensate possible deviations (without the presence of a foreign body) along the ring.

A further option consists of at least partly compensating a change in the field strength, which emerges from the properties of the power coil arrangement itself, in a manner dependent on the location with the aid of the embodiment or the setting of the sensitivities. While the preceding paragraph assumes that the field strength along a ring remains substantially constant, the case where the field strength changes with location is considered here. This is particularly the case for coils which are arranged with different proximities to the outer edge of all coils or of the foreign-body detection device (i.e. which are situated at different radial positions). In the case of a radial field profile (for example if the power inductive charging device or the transmission coil is a cylindrical coil), the field strength decreases with increasing distance from the center of the field (i.e. in the radial direction). This spatially dependent variance and, in general, all variances of the field strength which are spatially dependent can be at least partly compensated by an appropriate realization or setting of the sensitivities.

In accordance with one embodiment, the power coil arrangement (or, in general, the transmission coil) has a field strength distribution with a spatially dependent variance, in particular a radial variance. The coils have sensitivities which have a spatially dependent variance. These sensitivities can have this variance by design or control. As a result, the (at least partial) compensation is made possible. The spatially dependent variance of the sensitivities at least partly compensates the spatially dependent variance of the field strength distribution. If, in other words, the field strength distribution has a spatially dependent variance in one direction which conveys a decrease (or increase) of the field strength along this direction, the spatially dependent variance of the field strength distribution reproduces an increase (or decrease). The strength of the change in the sensitivities in one direction (in general: in a spatially dependent manner) can correspond to the strength of the change of the field strength, can overcompensate the latter or it can be less than the latter and thereby only compensate the latter in part.

As a result of this compensation, the same signals (i.e. lying within a tolerance window) emerge (directly from the coils or after matching or level matching) in the case of a (spatially dependently varying) field strength such that a foreign body can be identified on the basis of a deviation of the signals amongst themselves. However, if the signal levels without a foreign body being present are already different due to different sensitivities or due to a varying field strength distribution, a foreign body can no longer be detected by simple comparison.

Furthermore, the foreign-body detection device can be configured with a substrate and the multiplicity of coils, with the coils being formed by at least one structured, conductive layer which is carried by the substrate. In other words, the foreign-body detection device may be substrate-based.

The substrate can be flexible or rigid. The substrate and the at least one layer can be embodied as a single ply or multi-ply printed circuit board. The at least one structured, conductive layer can be embodied as a metal layer. The at least one structured, conductive layer can form one or more conductor tracks.

The at least one layer is preferably structured on the basis of recesses which extend through the entire thickness of the respective layer. The recesses are milled recesses, etched recesses, stamped recesses or recesses generated by way of laser ablation. Alternatively, the conductive, structured layer can be an originally formed layer, e.g. a printed or sintered layer.

Provision can be made of a capping ply, preferably made of an electrically insulating material, with the capping ply being arranged over the at least one structured, conductive layer in order to cover the latter.

The at least one structured, conductive layer is partly or completely embedded in the substrate. Furthermore, the structured, conductive layer can be fastened to the substrate, for example by means of an adhesive connection.

The foreign-body detection device can moreover comprise a circuit and/or components. The circuit and/or the components can realize the adjustment device, level matching apparatus, the comparator, the evaluation circuit, the error signal generator described here, or other circuit parts or components described here (such as the capacitors, inductors, switches, damping members, amplifiers etc. described here).

The circuit can comprise a level matching apparatus, such as active or passive damping members or an amplifier. The level matching apparatus can have an input connected to the coils and/or wherein the components are connected in parallel or series with the coils, wherein the components are capacitors in particular, said capacitors forming a resonant circuit with the coils in each case, and/or the components are resistors which form resonance damping elements with the coils, and/or the components are discrete inductors which are embodied as matching elements for the inductance values of the coils. These components can be partly or completely assembled at the substrate in or on which the coils are provided as well. In particular, these components can be connected with one another and/or with the coils by way of the at least one electrically conductive, structured layer.

The coils or a subgroup of the coils can be arranged next to one another and have a coil area which extends along the substrate.

The power inductive charging device can comprise at least one substrate-based foreign-body detection device as described here. The power inductive charging device can furthermore comprise a power coil arrangement along which all or some of the multiplicity of coils of the substrate-based foreign-body detection device extend.

In order to block interference signals, provision can be made of a filter which is disposed downstream of the coils. The filter can be provided in front of, or within, the adjustment device or the matching apparatus. The filter is frequency selective; in particular, it is a low-pass, a high-pass or else a band-pass filter. The band-pass filter can be embodied in the form of a resonant circuit, in particular in the form of an LC resonant circuit, in which the coil forms the inductance L of the resonant circuit. Alternatively, use can be made of filters disposed downstream of the coils, which filters are embodied as analog and/or digital filters. In particular, a predetermined frequency corresponding to the frequency of the alternating field is situated in the pass range, for the detection of which frequency of the alternating field the coils are configured.

### BRIEF DESCRIPTION OF THE DRAWING

FIG. 1 is a schematic plan view of a foreign-body detection device according to the invention; and

FIG. 2 depicts a foreign body detection device.

### DETAILED DESCRIPTION OF THE DRAWING

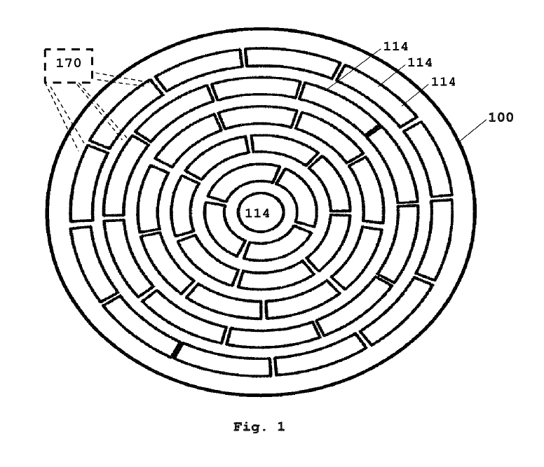

FIG. 1 is a schematic plan view of a foreign-body detection device according to the invention, wherein a number of coils 114 are formed within a circular form (depicted by the circumferential line 100) by way of the at least one structured, conductive layer. As depicted by the dashed lines, a symbolically illustrated circuit 170 is connected to the individual coils 114.

The circuit 170 can be an adjustment device as described here. The circuit 170 can comprise at least one of the following components or consist thereof: a controllable switching element which, in particular, is connected to taps of the respective coil, a preferably variable series or parallel resistor, an amplifier, preferably with an adjustable gain factor, a damping member, preferably with an adjustable damping factor, for example a voltage divider, and/or an inductor or a capacitor which, in particular, is able to be connected thereto or separated therefrom in a controllable manner.

Alternatively, or in combination herewith, the circuit 170 can comprise a level matching apparatus as described here, or it can consist of the latter. The level matching apparatus can have at least one active or passive damping member or at least one amplifier. These can have an input which, in particular, is connected to the coils. The level matching apparatus can furthermore have components which are connected in parallel or in series with the coils. In particular, the components are capacitors which preferably in each case form a resonant circuit with the coils. Furthermore, the level matching apparatus can comprise components, which are resistors in particular, which form resonant damping elements with the coils. Furthermore, the components can be discrete inductors, which are embodied as preferably discrete matching elements for the inductance values of the coils.

The circuit 170 can furthermore comprise an error signal generator which, in particular, is disposed downstream of the comparator. The error signal generator can be configured as described herein.

The circuit 170 is connected to the coils 114 by way of conductor tracks in particular, wherein the conductor tracks and the coils are embodied from the same conductive, structured layer. Furthermore, the coils and the conductor tracks, optionally also connections within the circuit or components of the circuit, can be formed from the same printed circuit board, in particular from the same or from different conducting, structured layers of the printed circuit board.

The coils depicted in FIG. 1 have the form of circular ring segments. These follow one another both in the radial direction and in the circumferential direction of the foreign-body detection device in FIG. 1. The coils are arranged along rings lying within one another. The rings are depicted as circular rings in FIG. 1, but the rings can also have a different basic form to that of a circle, for example an oval, an ellipse, a polygon, a polygon with rounded corners or any other form which can be represented by a closed line.

As illustrated, there are gaps between the individual coils, said gaps, in particular, spacing adjacent coils apart from one another in the radial direction and/or in the circumferential direction. This indirect stringing together renders it possible to provide conductors between the coils. The coils with different radial distances from the center (or different distances from the circumferential line of the foreign-body detection device, the circumferential line encompassing the coils 114) can have an angular offset from one another, such as e.g. the coils of the outermost ring and the second outermost ring, or they can be situated in the same angular region, like e.g. the coils of the second outermost ring and third outermost ring which are at the top in the plane of the drawing, along which the coils are arranged. In particular, the circumferential line 100 corresponds to the outer edge and vice versa.

The coils are arranged in groups, wherein the distance from the center (or from the circumferential line 100) is the same in each group and coils of different groups have different (radial) distances. In particular, coils with the same distance from the center have the same cross-sectional area and, preferably, the same form as well. Furthermore, coils with different distances from the center of the device can have the same cross-sectional area. It is possible to identify that the coil 114 situated in the center is circular. Therefore, the coils can also have different forms. Preferably, coils with the same (radial) distance from the center have the same geometric form. In FIG. 1, all coils not situated in the center have substantially the same form, namely the form of a ring sector or, more specifically, of a circular ring sector and only differ in terms of the bending radius.

Preferably, all coils are connected to the circuit 170. Furthermore, a plurality of circuits 170 can be arranged in the foreign-body detection device and hence on the printed circuit board such that all coils are also connected to such circuits. By way of example, the circuit 170 serves for amplification, damping or else level matching. Furthermore, the circuit can have capacitors which form resonant circuits together with the coils.

In the last-mentioned case, the resonant frequencies of the resonant circuits, the coils of which are depicted in FIG. 1, are substantially equal. The circuit 170 need not necessarily be provided outside of the arrangement of coils but can also be situated between the coils, at least in part, and, in particular, also be distributed across the printed circuit board which reproduces the coils depicted in FIG. 1.

FIG. 1 merely depicts the outlines of the coils; feed lines only are depicted in an exemplary manner at the upper left-hand edge using dashed lines. The arrangement form of the coils of the foreign-body detection device used in FIG. 1 is a circle. As an alternative to this manifestation, use can also be made of an oval, an ellipse or any other form, such as a polygon or else a polygon with rounded corners. In particular, the arrangement form of the coils of the foreign-body detection device 114 is substantially the same as the form of the power coil unit if the foreign-body detection device is combined with such a power coil arrangement.

In FIG. 1, the coils are depicted as groups, the form of which corresponds to the overall form (circular or ring form) of the foreign-body detection device. Since the basic form depicted in FIG. 1 is a circle, individual coils emerge as circular ring sectors with different radial distances from the center. Instead, use can also be made of general ring sectors, or else of coils which are not arranged radially but in a rectangular fashion in relation to one another, for example in the form of polygons, rectangles, hexagons or squares which follow one another in one direction, in particular in two mutually orthogonal directions. In the case of such an arrangement, the various groups can be offset from one another in such a way that columns or rows emerge, the elements of which are offset from one another from row to row or from column to column. Alternatively, such coils can also be arranged without an offset from one another.

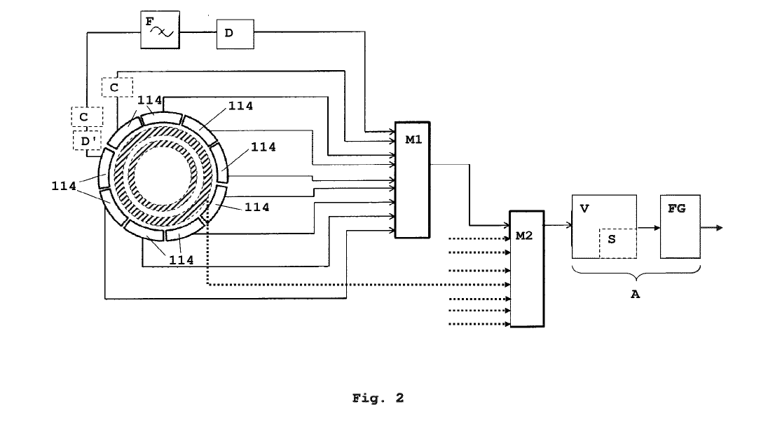

FIG. 2 shows a foreign-body detection device comprising a multiplicity of coils 114 which are arranged in a ring-shaped manner. There is a schematic depiction of the fact that, within the ring of coils denoted by the reference sign 114, there are also further rings, along which coils extend, within this ring. The sensitivities of the coils 114, which extend along the same ring, are matched to one another, for example by the selection of the coil geometry, by the number of the coil windings or by other measures which relate to the embodiment of the coils. Alternatively, or in combination therewith, provision can be made of damping members D, D′. These are either depicted in a signal lead of a coil, as denoted by the reference sign D, or provided within a resonant circuit, as depicted by the reference sign D′. Hence, the foreign-body detection device can furthermore comprise at least one capacitor, preferably a capacitor for each coil, to which the coil is connected. Here, the capacitors can be arranged directly at the coil. Alternatively, one capacitor can be provided for each coil or, preferably, for a plurality of coils, for example within an adjustment device or within a level matching apparatus or an evaluation circuit. In particular, provision can be made of, in particular, a multiplexer between the capacitor and the coil such that a resonant circuit, which comprises the capacitor and the coil respectively selected by the switch or by the multiplexer, only emerges after appropriate setting of the circuit or the multiplexer. Moreover, the capacitor can be provided with a capacitance value with which the sensitivity can be realized in a targeted manner, by means of which sensitivity the desired (matched) sensitivity emerges.

Furthermore, provision can be made of a filter F which is disposed downstream of the coil 114, said filter being embodied, for example, as a low-pass, a high-pass or as a band-pass filter. Here, either the resonant frequency of the resonant circuit (comprising the relevant coil and the capacitor) lies around the transmission range of the filter or the frequency of the alternating field, which is provided to excite the foreign-body detection device, lies in the transmission range.

Finally, provision can be made of a damping element D, in particular a resistor, a voltage divider or else an adjustable, in particular electronic damping member, by means of which the sensitivity of the relevant coil can be matched. Instead of a damping member D, or in combination therewith, provision can be made of an amplifier at the relevant position, with the matching of the sensitivities of the coils being achievable with the gain factor of said amplifier.

The foreign-body detection device in FIG. 2 furthermore comprises a first multiplexer M1 and a second multiplexer M2. Both multiplexers each comprise an interface with a plurality of inputs. By selecting one input, the first multiplexer M1 selects a first group of all coils, in particular all coils which lie in the same angular range or which are grouped in a different manner, in particular in accordance with a geometric property. The second multiplexer renders it possible to select a subgroup and, in particular, an individual element and hence an individual coil 114, the signal of which is considered, from this group selected by the multiplexer M1. Here, the second multiplexer can be used, for example, to select the edge along which the selected subgroup of coils or the relevant coil extends. In the case of other coil arrangements, for example in accordance with a Cartesian coordinate system, the first multiplexer can serve to select the column while the second multiplexer M2 selects the line. Within this meaning, the multiplexer M1 depicted in FIG. 2 can also be used for the angle selection, corresponding to the line selection, while the multiplexer M2 is used for selecting the distance or the ring, corresponding to a column selection linked herewith. Hence, the multiplexer M1 can be used for the selection in accordance with a first criterion while the multiplexer M2 is suitable for selecting a second criterion of the relevant coil. The criteria used for the selection are orthogonal to one another such that, when applying both criteria, a subgroup of coils or, in particular, a single element, i.e. a single coil, emerges in each case, while the criteria in each case select a group of the coils. Instead of using multiplexers M1 and M2 nested within one another, use can also be made of a single multiplexer, by means of which a single coil or subgroup of coils can be selected directly from all coils.

FIG. 2 furthermore depicts an evaluation circuit A, which is disposed downstream of the coils 114 and the components C, D′, D and/or F, which can be considered as a matching circuit. In particular, at least one multiplexer M1 or M2 is situated between the evaluation circuit A and the coils or the components for matching, which are likewise disposed downstream.

The evaluation circuit A already receives signals which originate from coils, the sensitivities of which are already matched. Alternatively, matching can be undertaken in the evaluation circuit; additional matching can likewise take place. The evaluation circuit comprises a comparator V which evaluates the signal level of the coil, the sensitivity of which is already matched, in relation to a reference value or which evaluates the signal level of two coils in a comparative manner. The comparison result is forwarded to an error signal generator F which is disposed downstream of the comparator V. The latter is configured to generate an error signal if the result of the comparator V specifies that the levels deviate from one another by more than a threshold. Optionally, it is also possible to change this threshold in order to compensate different sensitivities at least in part.

The comparator V can comprise a memory S in which a reference value or a reference sector is stored. The reference value reproduces signal levels of individual coils, subgroups of coils or groups of coils during normal operation such that the level of the comparison result reproduces how strongly the field is influenced by the foreign body. The evaluation circuit A can be connected to the multiplexers, either directly or by virtue of a common actuator being connected to both such that the error signal emitted by the error generator F can comprise information about which coil or coils are selected by the multiplexer and applied to the evaluation circuit A.

### LIST OF REFERENCE SIGNS

100 Circumferential line
114 Coils
170 Circuit
A Evaluation circuit
C Capacitor
D, D′ Damping member within a resonant circuit or disposed downstream of the coils
F Filter
FG Error signal generator
M1, M2 First, second multiplexer
S Memory within comparator V
V Comparator

What is claimed is:

1. A foreign-body detection device comprising:
a plurality of coils arranged next to one another, the coils having the form of ring sectors, a plurality of the coils following one another both along a circumferential direction of the ring sectors and being perpendicular thereto.

2. The foreign-body detection device of claim 1, wherein the plurality of coils are subdivided into at least one subgroup of coils, the coils of the subgroup being configured to have sensitivities, which do not deviate from one another by more than a predetermined amount.

3. The foreign-body detection device of claim 2, wherein the coils of the same subgroup are arranged along the circumferential direction and the coils of the same subgroup are arranged perpendicular to the circumferential direction.

4. The foreign-body detection device of claim 3, wherein the sensitivities are defined by at least one of:
an inductance of the coils;
a gain of a matching circuit connected to the coils; and
detuning a resonant circuit partly formed by the coils, relative to a predetermined resonant frequency of the resonant circuit.

5. The foreign-body detection device of claim 4, further comprising:
an adjustment device connected to a corresponding coil, said adjustment device being configured to modify at least one of:
the inductance of the coil;
a gain factor; and
the tuning of the resonant circuit responsive to an adjustment signal.

6. The foreign-body detection device of claim 5, further comprising a level matching apparatus, the level matching apparatus comprising:
an amplifier having an input connected to at least one of the coils;
a capacitor connected to the at least one coil;
said capacitor and the at least one coil forming a resonant circuit.

7. The foreign-body detection device of claim 2, further comprising an evaluation circuit comprising:
a comparator having a first input selectably connected to each of the coils (114) of the at least one subgroup, the comparator having a second input configured to receive a reference value, the comparator being configured to establish a difference between a signal at the first input and the reference value.

8. The foreign-body detection device of claim 7, further comprising an error signal generator operatively coupled to an output of the comparator, said error signal generator being configured to generate an error signal responsive to a difference between the signal at the first input and the reference value, said error signal corresponding to a deviation from a predetermined value, the deviation identifying a location of the coil whose signal deviates by more than a predetermined value.

9. An inductive charging device for motor vehicles, the charging device comprising:
a foreign-body detection device comprising a plurality of coils arranged next to one another, the coils having the form of ring sectors, a plurality of the coils following one another both along a circumferential direction of the ring sectors and being perpendicular thereto; and
a power coil arrangement, along which the plurality of the coils of the foreign-body detection device extend.

10. The power inductive charging device of claim 9, wherein the power coil arrangement is sized, shaped and arranged to provide a magnetic field strength distribution having a spatially dependent variance, wherein the coils have sensitivities which have a spatially dependent variance, and wherein the spatially dependent variance of the sensitivities at least partly compensates the spatially dependent variance of the field strength distribution.
